(19) United States
(12) Patent Application Publication
(10) Pub. No.: US 2006/0090300 A1
(43) Pub. Date: May 4, 2006

(54) Flexible bottle handle

(76) Inventor: Tae Jin Kim, Seoul (KR)

Correspondence Address: BACON & THOMAS, PLLC, 625 SLATERS LANE, FOURTH FLOOR, ALEXANDRIA, VA, 22314, US

(21) Appl. No.: 10/527,965

(22) PCT Filed: Dec. 29, 2003
(86) PCT No.: PCT/KR03/02872

§ 371 Date: Mar. 15, 2005

(30) Foreign Application Priority Data
Mar. 21, 2003 (KR) 20 2003 0008577

(51) Int. Cl. A47J 45/07

(52) U.S. Cl. 16/425

(57) ABSTRACT

Disclosed is a handle for bottle, which can prevent slip of the bottle from a user's hand or pouring-out of fluid contained in the bottle due to bending of a waist portion of the bottle when the user drinks the fluid contained in the bottle. The handle for bottle includes: a ribbon made of flexible material and positioned on one side surface of a bottle vertically, the central portion of the ribbon being fixed to the central part of the bottle by a trademark attaching film, which wraps the central part of the bottle; and a pair of coupling members adhered on both end portions of the ribbon, wherein the both end portions of the ribbon are bended in upward and downward directions respectively and the coupling members are coupled with each other to form a ribbon type handle for allowing the user to fit one hand into the ribbon type handle or grasp the ribbon type handle with one hand.

### TECHNICAL FIELD

The present invention relates to a handle for bottle, and more particularly, to a handle for bottle, which is a flexible ribbon type handle formed in such a manner that a ribbon having a pair of coupling members such as buttons or Velcro tapes adhered on both end portions of the ribbon is attached on a side surface of the bottle vertically, the central portion of the ribbon is compressed and fixed onto the central portion of the bottle by a film bearing a trademark, and then, the pair of the coupling members are coupled with each other.

### BACKGROUND ART

In general, a glass bottle or a PET bottle is slipped down from a user's hand and damaged due to dewing and dampness caused by a temperature difference occurring during keeping of fluid contained in the bottle, and in case of a large-sized PET bottle, fluid contained therein is frequently poured out due to bending of the waist portion thereof. To avoid the above problem, a handle formed at one side of the bottle for grasping the bottle with one hand safely is needed.

However, the conventional bottle having the handle formed at the one side thereof has several disadvantages in that the handle formed at the one side of the bottle may be easily damaged due to shock by collision generated when the bottle is carried or kept, or the whole weight of the bottle is increased by the formed at the one side of the bottle.

### DISCLOSURE OF INVENTION

Accordingly, the present invention is directed to a handle for bottle that substantially obviates one or more problems due to limitations and disadvantages of the related art. An object of the present invention is to provide a handle for bottle, which is not easily damaged by external force, which can prevent increase of volume of the existing bottle, and which can allows a user to drink fluid contained therein safely and conveniently by fitting the user's hand into the handle or grasping the handle with one hand.

To achieve these objects and other advantages and in accordance with the purpose of the invention, as embodied and broadly described herein, the handle for bottle comprises: a ribbon made of flexible material and positioned on one side surface of a bottle vertically, the central portion of the ribbon being fixed to the central part of the bottle by a film bearing a trademark, which wraps the central part of the bottle; and a pair of coupling members adhered on both end portions of the ribbon, wherein the both end portions of the ribbon are bended in upward and downward directions respectively and the coupling members are coupled with each other to form a ribbon type handle when the bottle is used.

It is preferable that the ribbon is made of leather or synthetic resin material.

It is preferable that the coupling members are a female button and a male button or a pair of Velcro tapes.

### BRIEF DESCRIPTION OF THE DRAWINGS

Further objects and advantages of the invention can be more fully understood from the following detailed description taken in conjunction with the accompanying drawings in which:

FIG. 1 is a perspective view of a handle for bottle according to the present invention;

FIG. 2 is a front view of the handle for bottle:

FIG. 3 is a perspective view showing a process in which a pair of buttons are coupled with each other; and

FIG. 4 is a rear perspective view showing the process in which the buttons are coupled with each other.

### BEST MODE FOR CARRYING OUT THE INVENTION

The present invention will now be described in detail in connection with preferred embodiments with reference to the accompanying drawings.

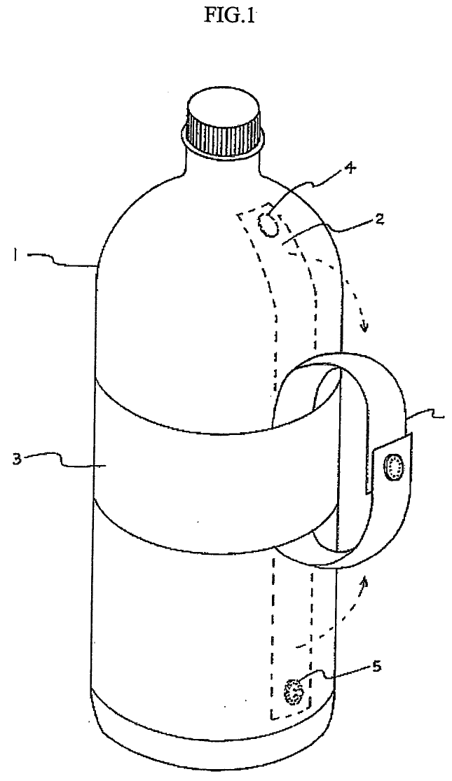

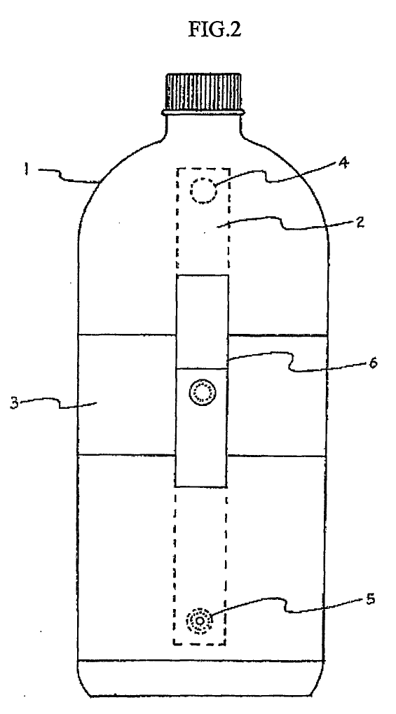

FIGS. 1 and 2 shows a handle for bottle according to the present invention, wherein a ribbon 2, which is made of flexible material such as leather or synthetic resin, is attached vertically on one side(front surface in the drawing) of a bottle 1 such as a glass bottle or a PET bottle. The ribbon 2 has a pair of coupling members, which are coupled with each other, i.e., a female button 4 and a male button 5, adhered at the upper and lower end portions thereof.

Here, it is preferable that the female button 4 is adhered on the inside of the ribbon 2, namely, in a direction toward the bottle 1, and the male button 5 is adhered in the outward direction, so that the female button 4 and the male button 5 are coupled with each other easily when a user bends the both end portions of the ribbon 2 in upward and downward directions. Of course, the present invention can provide the same effect as the above even though the female button 4 and the male button 5 are adhered in the opposed directions from each other, or even though Velcro tapes are adhered in place of the buttons.

As a film bearing a trademark 3, which has been typically attached on the bottle, is adhered at the central part of the bottle 1 while wrapping the central portions of the bottle 1 and the ribbon 2, the central portion of the ribbon 2 can keep a state in which it is fixed and adhered on the central part of the bottle 1, and the both end portions of the ribbon 2 can be easily bended in the upward and downward directions as not being adhered on the bottle 1 or being weakly attached on the surface of the bottle 1 by a low-viscosity adhesive.

That is, according to the material of the ribbon 2, the both end portions of the ribbon 2 are arranged near the bottle 1 by restoring force of the ribbon 2 itself or adhered on the surface of the bottle 1 by the low-viscosity adhesive, such that the ribbon 2 is not damaged when the bottle 1 is kept or carried.

Of course, ordinarily, as the both end portions of the ribbon 2 are weakly adhered on the surface of the bottle 1 or arranged near the bottle 1, the present invention can minimize an occupation area of the ribbon 2 during keeping and carrying of the bottle 1.

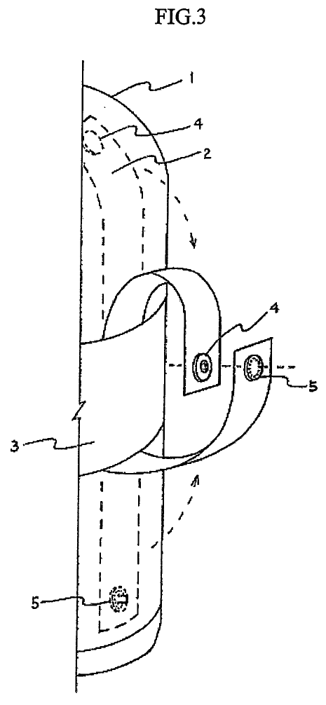

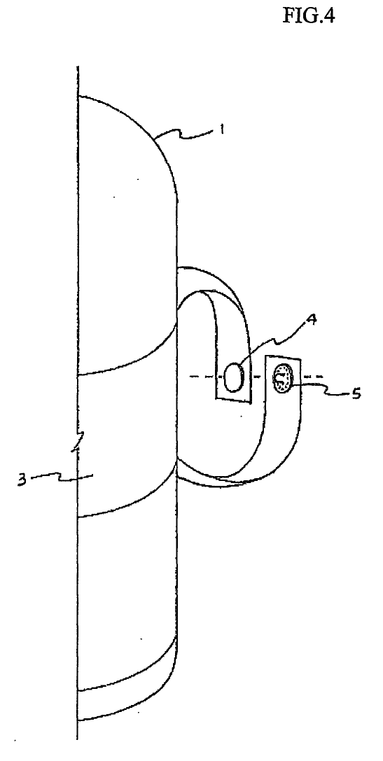

FIGS. 3 and 4 show a process in which a ribbon type handle 6 is formed by coupling the female button 4 and male button 5 with each other. To keep or carry the bottle 1, as shown by the dotted line in the drawings, the central portion of the ribbon 2 is attached at the central part of the bottle 1, and the both end portions of the ribbon 2 are arranged near the surface of the bottle 2, and thereby, it is not necessary to prepare a space for the ribbon type, handle 6 when the bottle is kept or carried, differently from the existing bottle having a handle.

As shown by the solid line in the drawings, to pour or drink fluid contained in the bottle 1, the user bends the both end portions of the ribbon 2 in the upward and downward directions respectively, and the, couples the female button 4 and the male button 5 with each other, and thereby, the ribbon type handle 6 for allowing the user to fit one hand into the handle or grasp the handle with one hand is formed.

Therefore, the user can pour or drink fluid contained in the bottle 1, such as the glass bottle or the PET bottle, safely without drop of the bottle 1 by fitting one hand into the ribbon type handle or by grasping the ribbon type handle with one hand.

### INDUSTRIAL APPLICABILITY

As described above, according to the present invention, a ribbon is adhered on one side surface of the bottle vertically, and the ribbon type handle is formed by coupling the female button and the male button, which are adhered on both end portions of the ribbon, so that the user can pour or drink fluid contained in the bottle 1, such as the glass bottle or the PET bottle, safely without drop of the bottle 1 by fitting one hand into the ribbon type handle or by grasping the ribbon type handle with one hand.

Furthermore, the user can carry the bottle by hanging the ribbon type handle on the user's finger and keep the bottle by hanging the ribbon type handle on a hook. Particularly, the ribbon type handle can be easily hung on the hook or grasped without regard to shapes of hooks or the users' hands as being made of flexible material.

Moreover, manufacturers for manufacturing fluid, which will be contained in glass bottles or PET bottles, can decorate the bottles using the ribbon according to characteristics of products or write various letters for explaining the corresponding products on the ribbon.

While the present invention has been described with reference to the particular illustrative embodiment, it is not to be restricted by the embodiment but only by the appended claims. It is to be appreciated that those skilled in the art can change or modify the embodiments without departing from the scope and spirit of the present invention.

What is claimed is:

1. A handle for bottle comprising:
a ribbon made of flexible material and positioned on one side surface of a bottle vertically, the central portion of the ribbon being fixed to the central part of the bottle by a film bearing a trademark, which wraps the central part of the bottle; and a pair of coupling members adhered on both end portions of the ribbon, wherein the both end portions of the ribbon are bended in upward and downward directions respectively and the coupling members are coupled with each other to form a ribbon type handle when the bottle is used.

2. The handle for bottle according to claim 1, wherein the ribbon is made of leather or synthetic resin material.

3. The handle for bottle according to claim 1, wherein the coupling members are a female button and a male button.

4. The handle for bottle according to claim 1, wherein the coupling members are a pair of Velcro tapes.
